(19) United States
(12) Patent Application Publication
(10) Pub. No.: US 2016/0024444 A1
(43) Pub. Date: Jan. 28, 2016

(54) GEL SOLVENT AND METHOD OF REMOVING DIFFUSION AND OVERLAY COATINGS IN GAS TURBINE ENGINES

(71) Applicant: United Technologies Corporation, Hartford, CT (US)

(72) Inventors: Eric W. Stratton, Mansfield, TX (US); Michael J. Minor, Arlington, TX (US)

(73) Assignee: UNITED TECHNOLOGIES CORPORATION, Hartford, CT (US)

(21) Appl. No.: 14/803,969

(22) Filed: Jul. 20, 2015

Related U.S. Application Data
(60) Provisional application No. 62/029,925, filed on Jul. 28, 2014.

(51) Int. Cl. C11D 17/00; C11D 7/08; C11D 7/26; C23G 1/02; B08B 3/08

(52) U.S. Cl. CPC C11D 17/003; C23G 1/02; B08B 3/08; C11D 7/268; C11D 7/08

(57) ABSTRACT

A method of stripping an engine component may comprise applying an acidic gel solvent to a coating of a surface of the engine component, leaving the acidic gel solvent on the surface of the engine component for a predetermined duration, and removing the acidic gel solvent from the surface of the engine component. The method may further include mixing an acid with a gelling agent to form the acidic gel solvent. The acid may comprise hydrochloric acid. The gelling agent may comprise a cellulosic material. The gelling agent may comprise a carbohydrate. The method may further include rinsing the acidic gel solvent from the surface of the engine component. The coating may comprise at least one of a diffusion coating or an overlay coating.

### CROSS-REFERENCE TO RELATED APPLICATIONS

This application is a nonprovisional of, and claims priority to, and the benefit of U.S. Provisional Application No. 62/029,925, entitled “GEL SOLVENT AND METHOD OF REMOVING DIFFUSION AND OVERLAY COATINGS IN GAS TURBINE ENGINES,” filed on Jul. 28, 2014, which is hereby incorporated by reference in its entirety.

### FIELD OF INVENTION

This application relates to removing coatings from parts in gas turbine engines, in particular, to removing coatings using a solvent in gel form.

### BACKGROUND OF THE INVENTION

Gas turbine engines may rely on metal components such as turbine hardware that may be treated with diffusion or overlay coatings to improve characteristics of the metal. Diffusion or overlay coatings may be applied to metal components, for example, compressor blades, disks or diaphragms as well as turbine blades, vanes, wheels and tip shoes. The metal components may benefit from stripping during its lifetime, for example, if a new coating is desired and/or if a partial new coating is desired. Diffusion and overlay coatings may be stripped by an immersion process. The immersion process may include removing the metal components (i.e., parts) from the engine and masking the parts prior to being submerged in a stripping agent. The masking tends to prevent uncoated surfaces from being exposed to the stripping agent. The immersion process may also attack unmasked base metal or base metal exposed during the stripping process. The process may further involve large tanks to immerse the parts in solvent, adding to the high cost of the immersion process.

### SUMMARY OF THE INVENTION

A method of stripping an engine component is provided. The method may comprise applying an acidic gel solvent to a coating of a surface of the engine component, leaving the acidic gel solvent on the surface of the engine component for a predetermined duration, and removing the acidic gel solvent from the surface of the engine component.

In various embodiments, the method may further include mixing an acid with a gelling agent to form the acidic gel solvent. The acid may comprise hydrochloric acid. The gelling agent may comprise a cellulosic material. The gelling agent may comprise a carbohydrate. The method may further include rinsing the acidic gel solvent from the surface of the engine component. The coating may comprise at least one of a diffusion coating or an overlay coating. The coating may comprise aluminum. The method may further include removing an additive layer of the coating while leaving a diffused layer of the coating. The acid may comprise a mineral acid. The method may further include determining a thickness of a remainder of the coating, reapplying the acidic gel solvent to the remainder of the coating, leaving the gel on the surface of the engine component for a second duration based on the thickness of the remainder of the coating. Reapplying the acidic gel solvent to the remainder of the coating may further include leaving a portion of the remainder of the coating devoid of the acidic gel solvent. The acidic gel solvent may be applied while the engine component is installed in a gas turbine engine.

A method of using a gel solvent may comprise applying the gel solvent to a metal surface to remove a metallic coating from the metal surface. The gel solvent may comprise hydrochloric acid and cellulose. The method may further comprise removing the gel solvent from the metal surface. The gel solvent may be left on the metal surface for a predetermined duration. The gel solvent may be heated while the gel solvent is on the metal surface. The metal surface may comprise a surface of a part installed in a gas turbine engine.

A gel solvent for removing aluminum coatings may comprise hydrochloric acid and cellulose mixed with the hydrochloric acid. The gel solvent may comprise 20%-30% of the hydrochloric acid by weight. The gel solvent may comprise 5%-10% of the cellulose by weight. The forgoing features and elements may be combined in various combinations without exclusivity, unless expressly indicated herein otherwise. These features and elements as well as the operation of the disclosed embodiments will become more apparent in light of the following description and accompanying drawings.

The forgoing features and elements may be combined in various combinations without exclusivity, unless expressly indicated herein otherwise. These features and elements as well as the operation of the disclosed embodiments will become more apparent in light of the following description and accompanying drawings. It should be understood, however, the following description and drawings are intended to be exemplary in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the figures, wherein like numerals denote like elements.

FIG. 1 illustrates cross-sectional view of an exemplary gas turbine engine, in accordance with various embodiments.

FIG. 2 illustrates a process of using a gel solvent to remove a diffusion or overlay coating from a metallic part of a gas turbine engine, in accordance with various embodiments.

FIGS. 3A-3C illustrate a process of using an acidic gel solvent to remove a diffusion or overlay coating from a metallic part of a gas turbine engine, in accordance with various embodiments.

FIG. 4A illustrates the application of a gel solvent to a metallic part of a gas turbine engine to remove an overlay coating, in accordance with various embodiments.

FIG. 4B illustrates a metallic part of a gas turbine engine after removal of a gel solvent, in accordance with various embodiments.

FIG. 4C depicts the results of application of a gel solvent to a metallic part of a gas turbine engine to remove an overlay coating, in accordance with various embodiments.

FIG. 5A illustrates the application of a gel solvent to a metallic part of a gas turbine engine to remove a diffusion coating, in accordance with various embodiments.

FIG. 5B illustrates a metallic part of a gas turbine engine after removal of a gel solvent, in accordance with various embodiments.

FIG. 5C depicts the results of application of a gel solvent to a metallic part of a gas turbine engine to remove a diffusion coating, in accordance with various embodiments.

FIG. 6A illustrates the application of a gel solvent to a metallic part of a gas turbine engine to partially remove a diffusion coating, in accordance with various embodiments.

FIG. 6B illustrates a metallic part of a gas turbine engine after removal of a gel solvent, in accordance with various embodiments.

FIG. 6C depicts the results of application of a gel solvent to a metallic part of a gas turbine engine to partially remove a diffusion coating, in accordance with various embodiments.

FIG. 7A illustrates a metallic part of a gas turbine engine with a gel solvent applied over a portion of a surface without using a mask, in accordance with various embodiments.

FIG. 7B illustrates a metallic part of a gas turbine engine with a gel solvent removed from a portion of a surface without using a mask, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the inventions, it should be understood that other embodiments may be realized and that logical changes and adaptations in design and construction may be made in accordance with this invention and the teachings herein. Thus, the detailed description herein is presented for purposes of illustration only and not of limitation. The scope of the invention is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

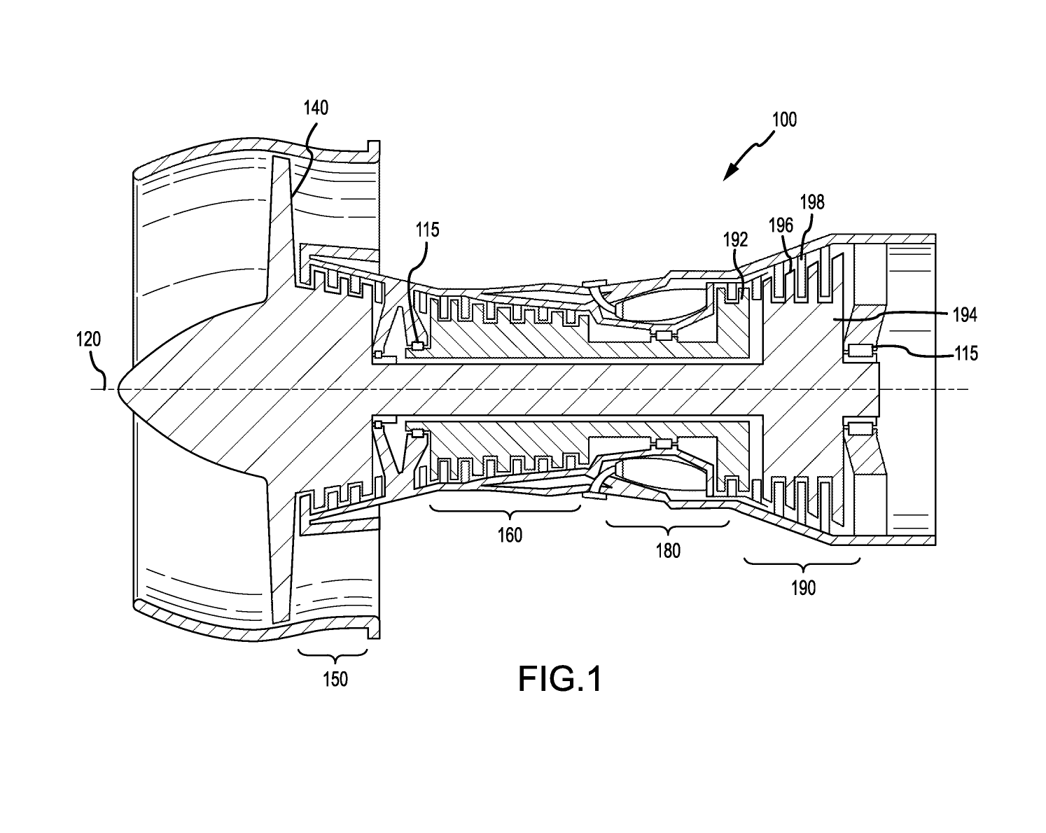

Referring to FIG. 1, a gas turbine engine 100 (such as a turbofan gas turbine engine) is illustrated according to various embodiments. Gas turbine engine 100 is disposed about axial centerline axis 120, which may also be referred to as axis of rotation 120. Gas turbine engine 100 may comprise a fan 140, compressor sections 150 and 160, a combustion section 180, and a turbine section 190. Air compressed in the compressor sections 150, 160 may be mixed with fuel and burned in combustion section 180 and expanded across turbine section 190. Turbine section 190 may include high pressure rotors 192 and low pressure rotors 194, which rotate in response to the expansion. Turbine section 190 may comprise alternating rows of rotary airfoils or blades 196 and static airfoils or vanes 198. A plurality of bearings 115 may support spools in the gas turbine engine 100. Any parts in gas turbine engine 100 may comprise a metallic diffusion or overlay coating to improve high temperature performance. For example, high pressure rotors 192, low pressure rotors 194, blades 196, or vanes 198 may be coated with an aluminum-based overlay or diffusion coating. FIG. 1 provides a general understanding of the sections in a gas turbine engine, and is not intended to limit the disclosure. The present disclosure may extend to all types of turbine engines, including turbofan gas turbine engines and turbojet engines, for all types of applications.

In various embodiments, a gel solvent may be used to strip overlay or diffusion coatings from parts of a gas turbine engine. The gel solvent may comprise a gelling agent mixed with a corrosive substance such as an acid or a base. Thus, the gel solvent may be an acidic gel or a basic gel and may attack all or a portion of diffusion coatings and overlay coatings while leaving the base metal substantially undamaged. The gel solvent may be applied locally and may remove coatings from parts without involving removal of the parts from an aircraft engine. The gel solvent may have greater viscosity and adhesive qualities than a liquid solvent to adhere to a part with little or no masking to prevent the gel solvent from contacting an uncoated metal surface or a coated surface that is not in need or desire to be stripped.

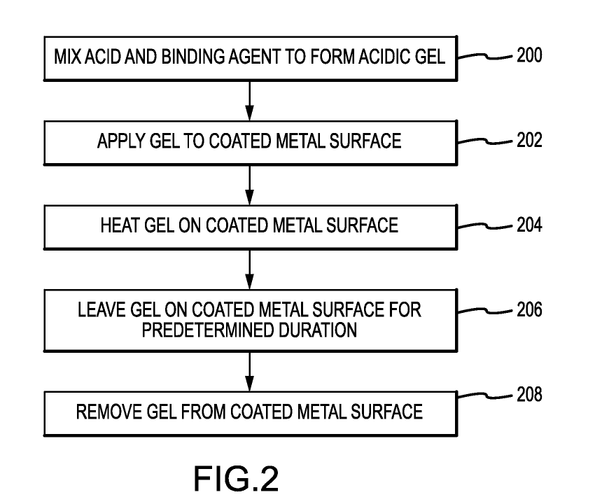

FIG. 2 illustrates a flow chart for an exemplary method of using a gel solvent to strip diffusion or overlay coatings from a gas turbine engine component, in accordance with various embodiments. In step 200, a gel solvent is made. The gel solvent may be made by mixing a gelling agent with a corrosive substance. A corrosive substance may comprise any material capable of at least partially dissolving a coating on a metal substrate. For example, a solvent may include an acid and/or a base, such as a strong acid or a strong base.

A gelling agent may comprise any material capable of forming a gel during and/or after mixing with a solvent. For example, a gelling agent may be a binding or thickening agent. A gelling agent in accordance with various embodiments of the present disclosure may comprise one or more thickeners. Such materials may be natural, synthetic or semisynthetic, and may be organic/polymeric or inorganic substances, and/or mixtures thereof. Polymers may include homo-polymers, random co-polymers and block co-polymers. Polymers may also include proteins such as albumin, or other natural polymers such as chitin or xanthan. Polysaccharides such as cellulose and cellulosic materials may be used as thickening or binding agents. Inorganic binding or thickening agents may include, but are not limited to, such materials as clays and silica gel. A thickener used herein may be nonionic, anionic, cationic, or amphoteric, or an inorganic mineral or salt.

In step 202, the gel solvent is applied to a surface to strip a coating. The gel solvent may be left on the surface for a predetermined duration depending on the thickness of the coating. In step 204, the gel solvent is removed. The gel solvent may be removed by a rinse to neutralize or dilute the corrosive attributes of the gel solvent.

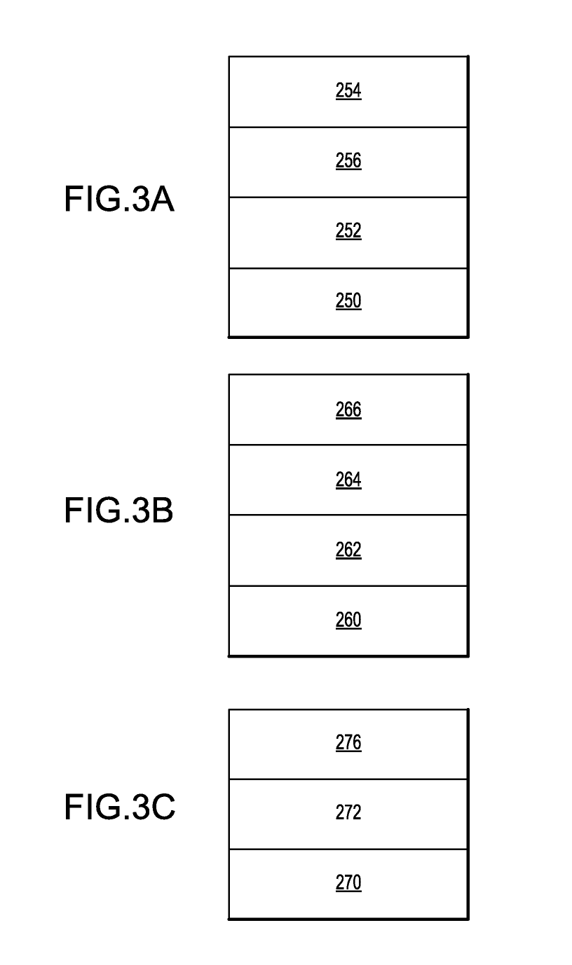

FIG. 3 illustrates a flow chart for an exemplary method of using an acidic gel solvent to strip diffusion or overlay coatings from a gas turbine engine component, in accordance with various embodiments. In step 210, an acid may be mixed with a gelling agent to create an acidic gel solvent. The acidic gel solvent may be water based so that water may be added to dilute the concentration of the acidic gel solvent.

In various embodiments, exemplary acids suitable for use as a solvent in the present compositions include, but are not limited to, one or more organic acids of any molecular weight, one or more mineral acids (inorganic acids), and mixtures thereof. Organic acids may include mono-carboxylic acids, di-carboxylic acids, or tri-carboxylic acids, and may be saturated or may have any degree of unsaturation. For example, organic acids for use in various embodiments of the composition in accordance to the present disclosure may include, but are not limited to, formic acid, carbonic acid, acetic acid, lactic acid, oxalic acid, propionic acid, valeric acid, enanthic acid, pelargonic acid, butyric acid, lauric acid, docosahexaenoic acid, eicosapentaenoic acid, pyruvic acid, acetoacetic acid, benzoic acid, salicylic acid, aldaric acid, fumaric acid, glutaconic acid, traumatic acid, muconic acid, malonic acid, malic acid, succinic acid, glutaric acid, adipic acid, pimelic acid, suberic acid, azelaic acid, abietic acid, pimaric acid, sebacic acid, phthalic acid, isophthalic acid, terephthalic acid, maleic acid, citric acid, and combinations thereof. For example, mineral acids for use in various embodiments of the composition in accordance to the present disclosure may include, but are not limited to hydrochloric acid (HCl), phosphoric acid, sulfuric acid, nitric acid, and combinations thereof. In various embodiments, HCl is used as a solvent.

In various embodiments, a gelling agent may comprise any material capable of forming a gel during and/or after mixing with a solvent. For example, a gelling agent may be a binding or thickening agent. A gelling agent in accordance with various embodiments of the present disclosure may comprise one or more thickeners. Such materials may be natural, synthetic or semisynthetic, and may be organic/polymeric or inorganic substances, and/or mixtures thereof. Polymers may include homo-polymers, random co-polymers and block co-polymers. Polymers may also include proteins such as albumin, or other natural polymers such as chitin or xanthan. Polysaccharides such as cellulose and cellulosic materials may be used as thickening or binding agents. Inorganic binding or thickening agents may include, but are not limited to, such materials as clays and silica gel. A thickener used herein may be nonionic, anionic, cationic, or amphoteric, or an inorganic mineral or salt.

In various embodiments, thickeners may be used to provide any one, or combination of, bulk, viscosity or rheology characteristics in the compositions. One or more thickeners may be added to impart certain rheology characteristics to the present compositions, such as a desired shear, yield, deformation, plasticity, elasticity, viscoelasticity, pseudo-plasticity, or the like. In various embodiments, one or more thickeners may also be added to impart other physical characteristics such as a dispensing volume and cling to surfaces.

In various embodiments, binding or thickening agents may include, but are not limited to, forms of cellulose such as carboxymethyl cellulose, carboxyethyl cellulose, hydroxyethyl cellulose, hydrophobically modified hydroxyethyl cellulose, hydroxypropyl cellulose, hydroxypropyl methyl cellulose, methyl cellulose, ethyl cellulose, microcrystalline cellulose, nitrocellulose and other cellulosic thickeners. In various embodiments, binding or thickening agents may include, but are not limited to polyvinyl alcohol, polyvinylpyrrolidone, polyvinylmethacrylate, polyacrylates, acrylate co-polymers such as acrylic acid/vinyl pyrrolidone cross-polymer, carboxyvinyl polymers, polyvinylacetate, polyvinyl co-polymers, polyurethanes, various starches, modified starches, dextrin, xanthan and other gums, agar, alginic acid and alginates, pectin, gelatin and other hydrocolloids, gelling agents, casein, albumin, chitin, collagen, silica gel, fumed silica, magnesium aluminum silicates, clay, bentonite, hectorite, and combinations thereof.

In various embodiments, one or more thickeners may be incorporated in the compositions of the present disclosure at levels of about 0.1 wt. % to about 10 wt. %, based on the total mass of the composition. For example, cellulose may be added to an acid to form an acidic gel solvent comprising 5-10 wt. % cellulose.

One or more organic and/or mineral acids may be incorporated in the compositions of the present disclosure at levels of about 10 wt. % to about 35 wt. %, based on the total weight of the composition. For example, 20° Baume HCl (˜9.8 M) may be mixed with cellulose to create an acidic gel solvent with HCl levels of about 20-30 wt. %. Water may be added to dilute the gel if a lower acid concentration desired. Moreover, HCl solutions of from about 2M to 15M may be mixed with cellulose. Other thickeners or acids may be added to enhance the physical characteristics of the gel. As used herein, an “HCl gel” may denote a gel comprising HCl and a gelling agent.

In step 212, the acidic gel solvent is applied to a coated metal surface. The acidic gel solvent may have high viscosity and strong adhesion characteristics so that the gel may stay substantially in place on a surface once applied. For example, an HCl gel may be applied to an aluminized coating such as an overlay or diffusion coating on the surface of a nickel alloy engine part to remove all or part of the aluminized coating. For example, the nickel alloy engine part may comprise a gas turbine engine part such as a compressor blade, disk or diaphragm or a turbine blade, vane, wheel or tip shoe. The acidic gel solvent may be applied to the metal surface using a nozzle, brush, sponge, tape, bath or other suitable applicator.

In step 214, the surface of the nickel alloy and the acidic gel solvent are heated to accelerate the reaction between the acidic gel solvent and coating on the surface of the nickel alloy. For example, the gel and metal surface to be stripped may be placed in an oven and heated to 130° F.-175° F. (51° C.-79° C.) to increase the rate at which HCl gel may attack a metallic coating.

In step 216, the water based, acidic gel solvent is left on the surface of the nickel alloy for a predetermined duration. The duration may depend on the concentration of acid in the gel and the thickness of the coating to be removed. The duration for which the gel is left on the surface may also depend on the type of coating to be removed. The duration may also depend on the thickness of the coating or the amount of the coating to be stripped. In some instances the coating may be only partially stripped. For example, a diffusion coating may comprise an additive layer and a diffusion layer above the pure base metal, where only the additive layer may be removed. The gel may be left on for a duration, or have a concentration, sufficient to dissolve the additive layer but leave the diffusion layer substantially unchanged.

In step 218, the acidic gel solvent may be removed from the surface of the nickel alloy. The acidic gel solvent may be removed using a reusable rinse or immersion in a rinse solution. The rinse solution may contain aluminum or other metals removed from the surface of the nickel alloy. The rinse may be neutralized and reused.

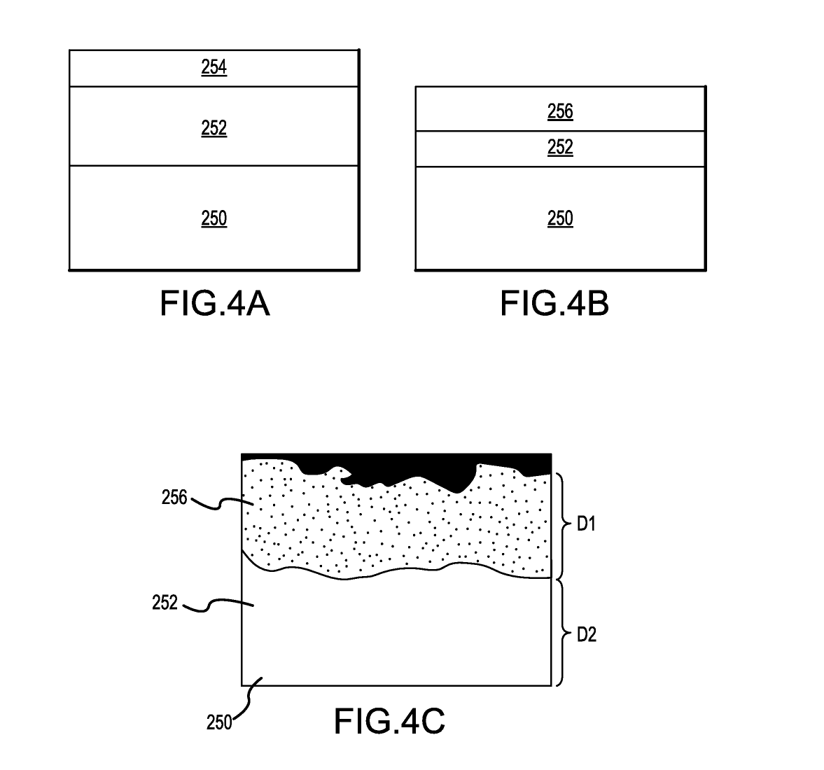

FIG. 4A illustrates the application of a gel solvent to a metallic part of a gas turbine engine to remove an overlay coating, in accordance with various embodiments. Base metal 250 has overlay coating 252 formed over a surface. Gel solvent 254 is applied on overlay coating 252. Gel solvent 254 may be left on overlay coating 252 until overlay coating 252 is removed to a desired depth or until gel solvent 254 is no longer attacking overlay coating 252. Gel solvent 254 may be heated while on overlay coating 252 to accelerate the reaction between gel solvent 254 and overlay coating 252.

FIG. 4B illustrates a metallic part of a gas turbine engine after removal of a gel solvent, in accordance with various embodiments. Gel solvent 254 has been rinsed or otherwise removed from base metal 250. Overlay coating 252 was attacked by gel solvent 254 and has a reduced thickness. Overlay coating may be fully or partially removed from base metal 250. Dust-like layer 256 remains on overlay coating 252. Dust-like layer 256 may be wiped away as desired.

FIG. 4C depicts the results of application of a gel solvent to a metallic part of a gas turbine engine to remove a portion of an overlay coating, in accordance with various embodiments. The surface of base metal 250 includes overlay coating 252 formed over the surface of base metal 250. Base metal 250 may be a high performance nickel-chromium alloy such as an austenitic nickel-chromium-based superalloy (e.g., INCONEL), for example. Gel solvent may have been applied over overlay coating 252 to remove a portion of overlay coating 252. The gel solvent may leave behind dust-like layer 256 after the gel solvent is removed. The dust-like layer 256 has a depth D1 of approximately 2.5-5 mil (64-127 μm). Overlay coating 252 remaining beneath dust-like layer has a depth D2 of approximately 3 mil (76 μm) where the depth of overlay coating 252 may have been approximately 9.5 mil (127 μm) before applying the gel solvent. Dust-like layer 256 may be a film and may be wiped away when gel solvent is removed. Overlay coating 252 may remain unaffected after gel solvent is rinsed away or neutralized as the depth to which gel solvent 254 attacks overlay coating 252 may be limited. Gel solvent may be re-applied to further remove overlay coating 252 as desired. Base metal 250 is not attacked by the gel solvent even where base metal 250 is exposed directly to the gel solvent. The gel solvent may be applied locally to remove overlay layers without requiring part removal, masking, or immersion.

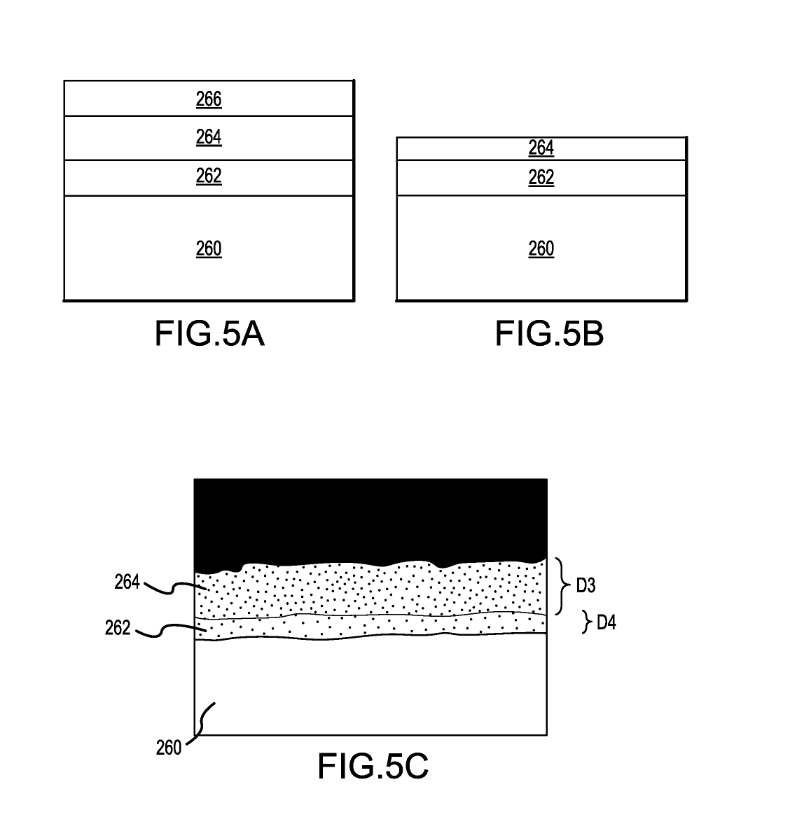

FIG. 5A illustrates the application of a gel solvent to a metallic part of a gas turbine engine to remove a diffusion coating, in accordance with various embodiments. Base metal 260 has a diffusion coating formed over its surface with diffusion coating comprising a diffusion layer 262 and an additive layer 264. Gel solvent 266 may be applied over additive layer 264. Gel solvent 266 may be left on diffusion coating until the diffusion coating is thinned or partially removed to a desired depth. Gel solvent 266 may be heated while on the diffusion coating to accelerate the reaction between gel solvent 266 and the diffusion coating.

FIG. 5B illustrates a metallic part of a gas turbine engine after removal of a gel solvent, in accordance with various embodiments. Gel solvent 266 has been rinsed or otherwise removed from base metal 260. Diffusion coating comprising diffusion layer 262 and additive layer 264 was attacked by gel solvent 266 and has a reduced thickness. Additive layer 264 has been partially removed from base metal 260.

FIG. 5C depicts the results of application of a gel solvent to a metallic part of a gas turbine engine to remove a diffusion coating, in accordance with various embodiments. Base metal 260 may be a high performance nickel-chromium alloy such as an austenitic nickel-chromium-based superalloy (e.g., INCONEL), for example. Base metal 260 has a diffusion layer 262 where the diffusion coating has diffused into the nickel based superalloy. Additive layer 264 may have a depth D3 of approximately 1.4 mil (35 μm) and diffusion layer 262 may have a depth D4 of approximately 0.7 mil (18 μm) thick. Additive layer 264 and diffusion layer 262 may form a diffusion coating with a total depth of approximately 2.1 mm. A gel solvent may have been applied over additive layer 264. Gel solvent 266 attacked additive layer 264 to a depth of 0.3-1 mil (8-25 μm) while leaving additive layer 264 with depth D3 as well as the entire diffusion layer 262 intact. Base metal 260 is not attacked by the gel solvent even where base metal 260 is exposed directly to the gel solvent. The gel solvent may be applied locally to partially remove a diffusion coating without requiring part removal, masking, and immersion.

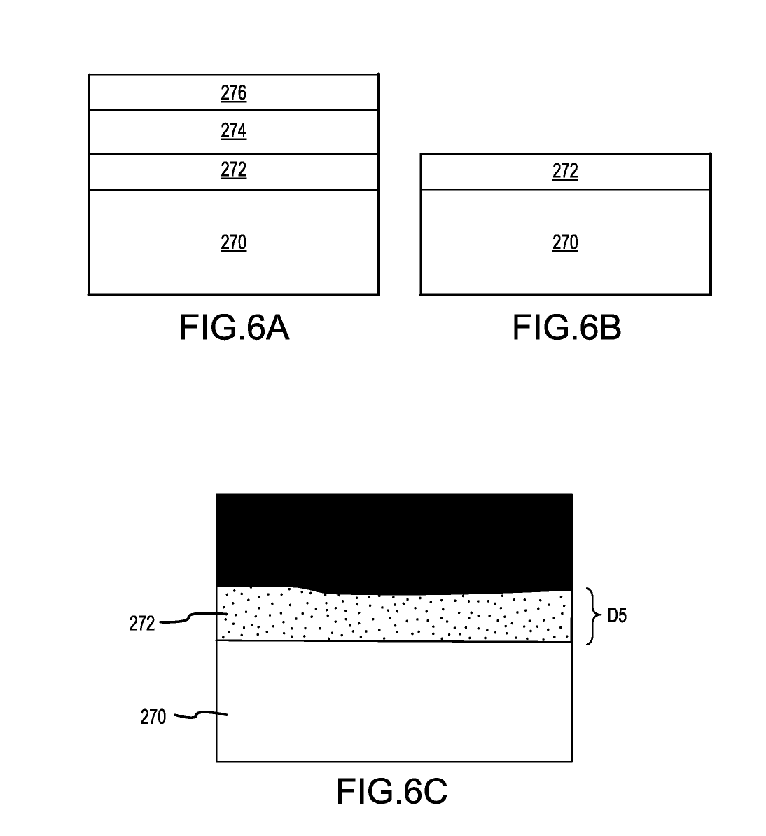

FIG. 6A illustrates the application of a gel solvent to a metallic part of a gas turbine engine to remove a diffusion coating, in accordance with various embodiments. Base metal 270 has a diffusion coating formed over its surface with diffusion coating comprising a diffusion layer 272 and an additive layer 274. Gel solvent 276 may be applied over additive layer 274. Gel solvent 276 may be left on diffusion coating until the diffusion coating is thinned or partially removed to a desired depth. Gel solvent 276 may be heated while on the diffusion coating to accelerate the reaction between gel solvent 276 and the diffusion coating.

FIG. 6B illustrates a metallic part of a gas turbine engine after removal of a gel solvent, in accordance with various embodiments. Gel solvent 276 has been rinsed or otherwise removed from base metal 270. Diffusion coating comprising diffusion layer 272 and additive layer 274 was attacked by gel solvent 276. Additive layer 274 has been completely removed from base metal 270 while diffusion layer 272 remains substantially unchanged.

FIG. 6C depicts the results of application of a gel solvent to a metallic part of a gas turbine engine to partially remove a diffusion coating, in accordance with various embodiments. Base metal 270 may be a high performance nickel-chromium alloy such as an austenitic nickel-chromium-based superalloy (e.g., INCONEL), for example. The diffusion coating may include diffusion layer 272 with depth D5 of approximately 1.4 mil (35 μm). Base metal 270 may be reacted with diffusion layer 272 where the aluminum based coating has diffused into base metal 270. The diffusion coating may have included an additive layer over diffusion layer 272 prior to application of a gel solvent, similar to the additive layer 264 in FIG. 4B. Returning to FIG. 4C, the gel solvent may have attacked and completely remove the additive layer while leaving diffusion layer 272 substantially unchanged. Base metal 270 is not attacked by the gel solvent even where base metal 270 is exposed directly to the gel solvent. Diffusion layer 272 is not attacked by the gel solvent even where diffusion layer 272 is exposed directly to the gel solvent. The gel solvent may be applied locally to remove the additive layer of a diffusion coating while leaving behind the entire diffusion layer. Thus, the gel solvent may be applied locally to partially remove a diffusion coating by entirely removing an additive layer without requiring part removal, masking, and immersion.

HCl in aqueous solution, as may conventionally be applied in an acid bath, may completely remove the additive layer, remove partially or remove completely the diffusion layer, and attack the base metal. An unexpected result of using gel solvent is that the gel solvent may remove the additive layer completely while leaving the diffusion layer completely or partially intact. The benefit of leaving the diffusion layer completely or partially intact is that the base metal that has reacted with the diffusion layer is not removed. Thus, the dimensions of the part may remain unchanged after application of the gel solvent.

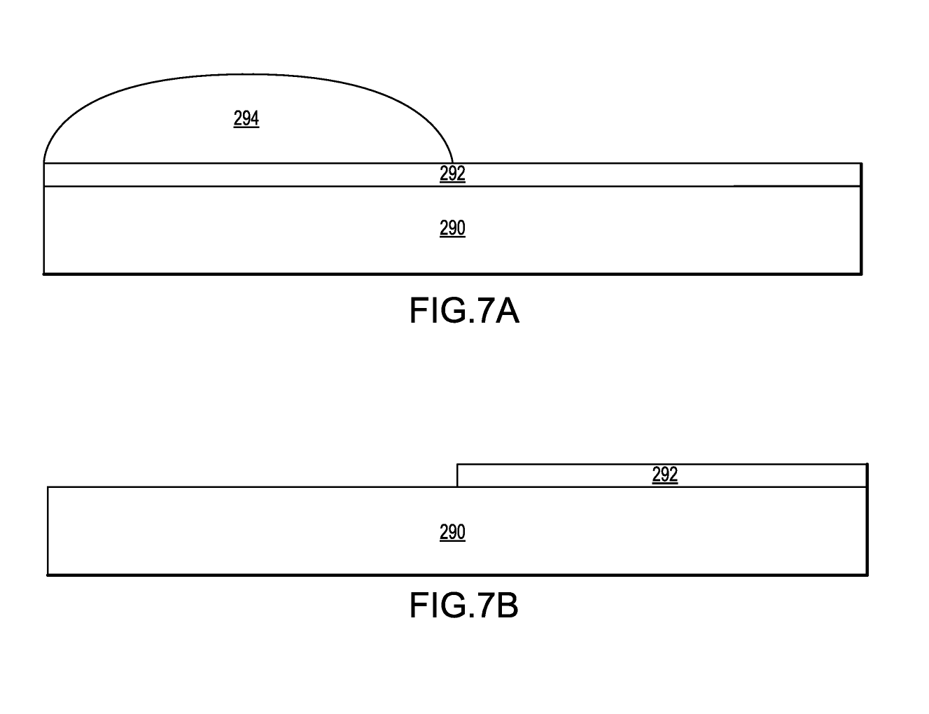

FIG. 7A illustrates a metallic part of a gas turbine engine with a gel solvent applied over a portion of a surface without using a mask, in accordance with various embodiments. Base metal substrate 290 of component may include diffusion or overlay coating 292 covering base metal substrate 290. Gel solvent 294 may be applied over a portion of base metal substrate 290 and on a portion of diffusion or overlay coating 292 while leaving a portion of diffusion or overlay coating 292 substantially free from gel solvent 294. Gel solvent 294 may stay substantially in position over diffusion or overlay coating 292. Gel solvent 294 may be applied using a maskless technique to leave a portion of diffusion or overlay coating 292 free from gel solvent.

FIG. 7B illustrates a metallic part of a gas turbine engine with a gel solvent removed from a portion of a surface without using a mask, in accordance with various embodiments. Gel solvent 294 may be removed from base metal substrate 290. The portion of base metal substrate 290 that was under gel solvent 294 has diffusion or overlay coating 292 at least partially removed from base metal substrate 290. A portion of diffusion or overlay coating 292 remains over the portion of base metal substrate 290 that was substantially free from gel solvent 294. Gel solvent allows diffusion or overlay coating 292 to be selectively removed from base metal substrate 290 without masking and without using an acid bath.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method of stripping an engine component, comprising:
applying an acidic gel solvent to a coating of a surface of the engine component;
leaving the acidic gel solvent on the surface of the engine component for a first duration; and
removing the acidic gel solvent from the surface of the engine component.

2. The method of claim 1, further including mixing an acid with a gelling agent to form the acidic gel solvent.

3. The method of claim 2, wherein the acid comprises hydrochloric acid.

4. The method of claim 2, wherein the gelling agent comprises a cellulosic material.

5. The method of claim 2, wherein the gelling agent comprises a carbohydrate.

6. The method of claim 1, further comprising rinsing the acidic gel solvent from the surface of the engine component.

7. The method of claim 1, wherein the coating comprises at least one of a diffusion coating or an overlay coating.

8. The method of claim 1, wherein the coating comprises aluminum.

9. The method of claim 1, further comprising removing an additive layer of the coating while leaving a diffused layer of the coating.

10. The method of claim 1, wherein the acid comprises a mineral acid.

11. The method of claim 1, further including:
determining a thickness of a remainder of the coating;
reapplying the acidic gel solvent to the remainder of the coating; and
leaving the gel on the surface of the engine component for a second duration based on the thickness of the remainder of the coating.

12. The method of claim 11, wherein reapplying the acidic gel solvent to the remainder of the coating further includes leaving a portion of the remainder of the coating devoid of the acidic gel solvent.

13. The method of claim 1, wherein applying the acidic gel solvent occurs while the engine component is installed in a gas turbine engine.

14. A method of using a gel solvent, comprising:
applying the gel solvent to a metal surface to remove a metallic coating from the metal surface, the gel solvent comprising hydrochloric acid and cellulose; and
removing the gel solvent from the metal surface.

15. The method of claim 14, further including leaving the gel solvent on the metal surface for a predetermined duration.

16. The method of claim 15, further including heating the gel solvent while the gel solvent is on the metal surface.

17. The method of claim 15, wherein the metal surface comprises a surface of a part installed in a gas turbine engine.

18. A gel solvent for removing aluminum coatings, comprising:
hydrochloric acid; and
cellulose mixed with the hydrochloric acid.

19. The gel solvent of claim 18, wherein the gel solvent comprises 20%-30% of the hydrochloric acid by weight.

20. The gel solvent of claim 18, wherein the gel solvent comprises 5%-10% of the cellulose by weight.
